(19) United States
(12) Patent Application Publication
(10) Pub. No.: US 2017/0295391 A1
(43) Pub. Date: Oct. 12, 2017

(54) ENTERPRISE THEATER MANAGEMENT SYSTEM

(71) Applicant: DOLBY LABORATORIES LICENSING CORPORATION, San Francisco, CA (US)

(72) Inventors: Dossym NURMUKHANOV, Millbrae, CA (US); Gary Kevin HALPIN, Daly City, CA (US); Thomas Turner PERSONS, Carmichael, CA (US); Henry BARNOR, Emeryville, CA (US); Eric Christopher CROWE, Walnut Creek, CA (US)

(73) Assignee: DOLBY LABORATORIES LICENSING CORPORATION, San Francisco, CA (US)

(21) Appl. No.: 15/482,161

(22) Filed: Apr. 7, 2017

Related U.S. Application Data
(60) Provisional application No. 62/320,585, filed on Apr. 10, 2016.

(51) Int. Cl. H04N 21/262; H04N 21/414

(52) U.S. Cl. CPC H04N 21/26283; H04N 21/26225; H04N 21/26258; H04N 21/41415

(57) ABSTRACT

Novel methods and systems for providing an enterprise theater management system are disclosed. A remote or cloud-based enterprise theater management system uses a ruleset to uniformly control theater playlist presentation for multiple theaters in either a point of sale controlled or fully autonomous manner, including the sequencing of theater cues with the playlist clips.

### CROSS REFERENCE TO RELATED APPLICATIONS

This application claims priority to U.S. Provisional Application 62/320,585, filed on Apr. 10, 2016, which is hereby incorporated by reference in its entirety. The present application also may be related to U.S. Provisional Application No. 62/320,583, filed on Apr. 10, 2016, the disclosure of which is incorporated herein by reference in its entirety.

### TECHNICAL FIELD

The present disclosure relates to improvements to movie theater screen handling systems.

### BACKGROUND

Theater Management Systems/Screen Management Systems

Movie theaters can utilize a Theater Management System (TMS) to control the shows the theater puts on, controlling show playlist (SPL) builds, schedules, pre-show advertisements, trailers, key delivery message (KDM) management, and content transfers. Additionally, the theater utilizes one or more Screen Management Systems (SMSs) which function in a similar capacity as the TMS but on a per-screen basis rather than for the entire theater. The TMS can queue up shows with ads, trailers, and main feature (e.g. movie) bundled together based on scheduling input from a Point of Sale (POS) device, which handles ticketing and feature scheduling for the theater.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### SUMMARY

An enterprise TMS (ETMS) can be utilized to create greater uniformity across commonly owned/affiliated theaters or to allow autonomous control of multiple theaters from one off-site location. The ETMS provides rules for the TMSs at the theaters for constructing playlists with appropriate advertising, trailers, cues, and display specifications based on factors such as the location of the theater, the feature being shown, the time the feature is scheduled for, the type of screen being used, and others.

In a first aspect of the disclosure, a computer based system for managing one or more movie theaters is described, the system comprising: an enterprise theater management system server, remote from the one or more movie theaters, configured to provide a show playlist to a movie theater of the one or more movie theaters based on a pre-defined ruleset.

In a second aspect of the disclosure, a computer based system for managing one or more movie theaters is described, the system comprising: an enterprise theater management system server, remote from the one or more movie theaters, configured to provide a show playlist and show schedule to a movie theater of the one or more movie theaters based on a pre-defined ruleset.

The enumeration of aspects of the disclosure is not intended to be limiting: further aspects of the disclosure can be discerned from the details herein.

### BRIEF DESCRIPTION OF DRAWINGS

FIG. 1 illustrates an example of one embodiment of the enterprise theater management system.

FIG. 2 illustrates an example of another embodiment of the enterprise theater management system.

FIG. 3 illustrates an example of an ETMS network using POS control.

FIG. 4 illustrates an example of an ETMS network without POS control.

FIG. 5 illustrates an example dataflow chart for an ETMS network.

FIG. 6 illustrates an example of hardware utilized for ETMS.

### DETAILED DESCRIPTION

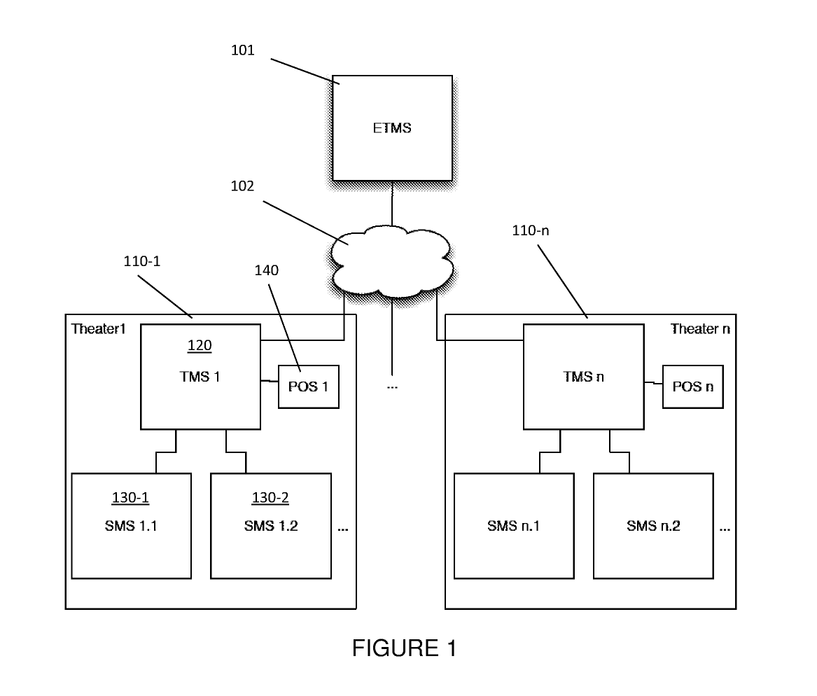

FIG. 1 shows an example of one embodiment of an ETMS. The ETMS control (101) is connected to various theaters (110-1 . . . 110-n) through a network (102). The network (102) can be a standard network, a VPN, a cloud-based system, or similar network. The TMS (120) of each theater (110-1) communicate with the POS (140) associated with that theater (110-1) to figure out when the shows are expected to play. The TMS (120) forwards this information to the ETMS (101), which in turn creates and schedules the shows for the theater (110-1). The schedule is pushed to the TMS (120). The TMS (120) can then communicate with one or more SMSs (130-1, 130-2, . . . ) to play the shows on their corresponding screens at the appropriate times with the appropriate cues.

In another embodiment, the ETMS (101) can define rules and/or templates for show creation, these rules/templates are then pushed to the TMSs (120). The TMSs (120) then use these rules/templates for show creation and scheduling, which is then conveyed to the SMSs (130-1, 130-2, . . . ) so that the shows are played on the appropriate screens at the appropriate times.

In another embodiment, the system can have show creation and scheduling being handled at the ETMS until the network (102) breaks the connection, for whatever reason, between the ETMS (101) and the TMS (120). When the TMS (120) detects that the connection to the ETMS (101) is down, it takes over responsibility for show creation and scheduling for its SMSs (130-1, 130-2, . . . ).

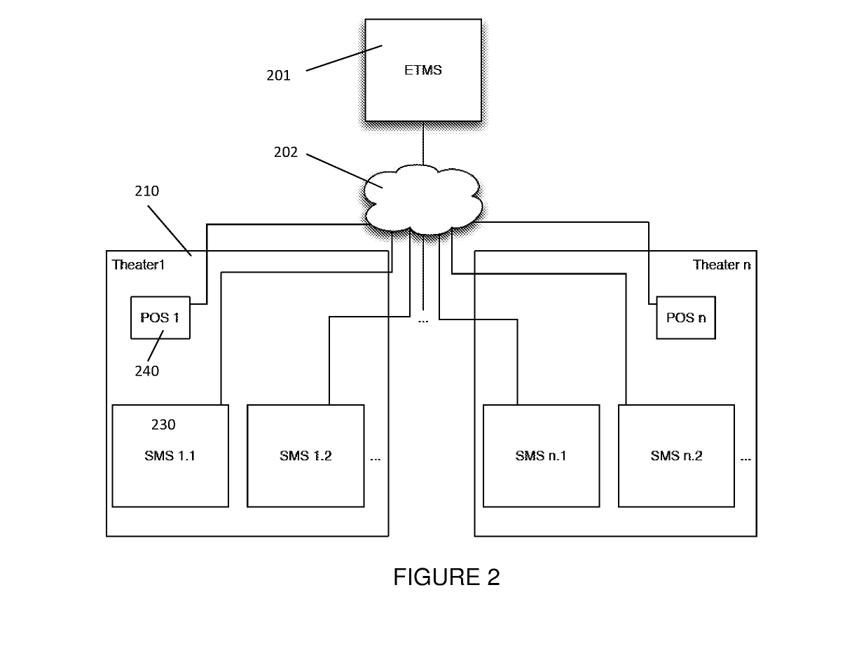

FIG. 2 shows an example of another embodiment of an ETMS. Rather than having a TMS that communicates with the ETMS (201), the theater (202) has an SMS (230) for each screen in the theater, and that SMS (230) communicates with the ETMS (201) through a network (202). The POS (240) of the theater (202) also communicates with the ETMS (201) through the network (202) directly, providing the ETMS (201) with the feature information. The ETMS (201) does show creation and scheduling, with the schedules being pushed directly to the appropriate SMS (230). The SMS (230) then causes the shows to be played at the appropriate times with the correct cues, as provided by the ETMS (201).

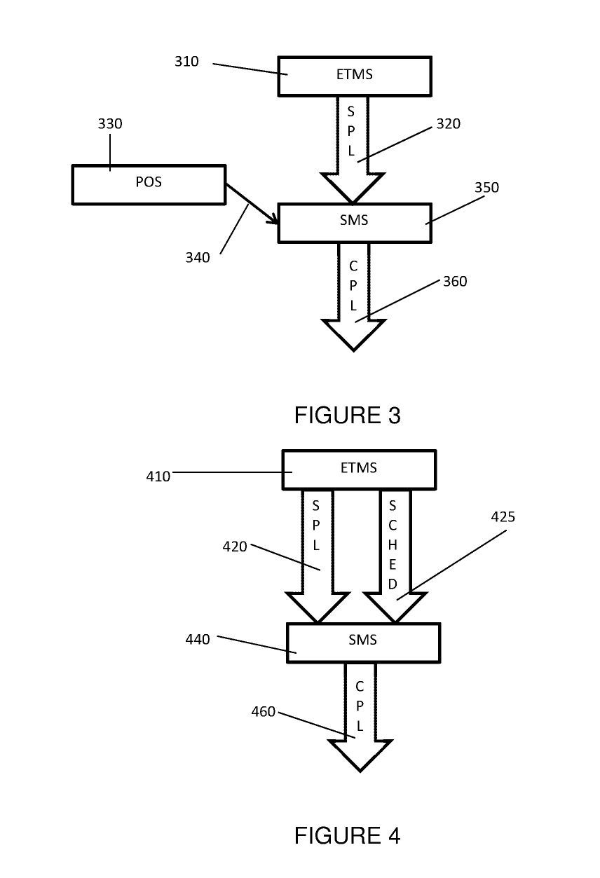

FIG. 3 illustrates an embodiment of the ETMS building shows based on POS input. The ETMS (310) builds show playlists (SPLs) (320) for the SMS (350). The SMS (350) takes the SPLs (320) and, based on input from the POS (330) as to which SPL it wants to showcase, uses content playlists (CPL) (360) to play the SPL (320) on the designated screen, along with cues indicated by the SPL (320). A TMS can also be included between the ETMS (310) and SMS (350), as shown in FIG. 1

The SPL (320) is a collection of clips/features (CPLs) and automation cues (lights up, lights down, audio volume, etc.) in a specified order. For example, an SPL can include a list of cues to open screen curtains, start audio, show advertisements, dim lights, show trailers, show the features, raise the lights, cut audio, and then close curtains in that order. It can also indicate that 3-D glasses are to be provided to audience members for that particular show and indicate special promotions associated with that show.

The SPL can be in the form of a template of content and cues. The template can be automatically populated from a set of pre-defined rules, and each feature is matched to a template. There are two types of rules: template rules and content rules. Template rules determine which template is used for a given feature. Content rules determine which clips (short piece of audio/video, such as advertising, trailers, policy notifications, pre-rolls, etc.) are tied to particular features. There are various methods of rule behavior: for example, rules based on location (specific theater/auditorium, set of theaters/auditoriums, geographical region, etc.), based on date/time (for example, daytime matinee vs. evening show), based on feature rating (PG, G, R, etc.), based on movie format (2D, 3D, 4K, Dolby Atmos™ sound, etc.), content based (which feature is being shown, or genre of feature), and other information. Given a set of rules/template, a feature to be shown, and a list of available clips and cues, the ETMS (or TMS) can generate an SPL to be scheduled for playback. For example, a 4K feature showing on a 4K screen might allow 4K versions of advertising and trailers.

A CPL is an ordered sequence of reels each referencing sound or picture files. Each reel is analogous to a film reel. The CPL controls the order and timing of the play-out of the reels, typically handled by an SMS. A CPL is also known as a “clip”.

The theater cues include a physical or logical action tied to a specific time within a show. The cues can be programmed into macros

FIG. 4 illustrates an embodiment of the ETMS building shows without the SMS needing POS input. The ETMS (410), having been provided feature information from a POS feed, builds SPLs (420) and SPL schedules (when each feature is to be shown) (425) to the SMS (440). From this, the SMS (440) utilizes CPLs (460) for playing the clips of the SPL at the appropriate times. This allows for autonomous (at the local level) theater show management, as the POS does not have to determine show scheduling. As with FIG. 3, a TMS can also be included between the ETMS (410) and SMS (440), as shown in FIG. 1.

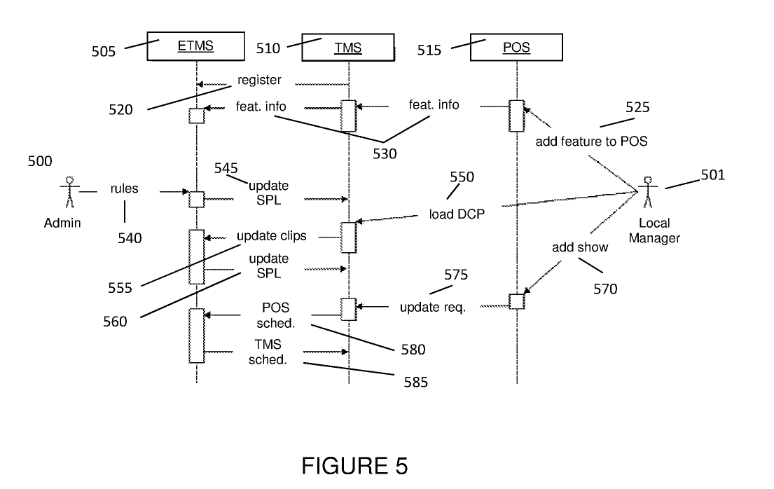

FIG. 5 illustrates an example protocol flow between a global administrator (500) located outside the theater, a local manager (501) located at the theater, the ETMS (505) controlled by the administrator, POS (515) controlled by the local manager (515), and a TMS (510) for the local manager's theater. The TMS (510) registers itself (520) with the ETMS (505), so the ETMS (505) not only knows it is responsible for the TMS (510), but it has information it can use for template filling, such as theater geographical location. The local manager (501) adds a new feature (525) to be played at the theater to the POS (515). The information about this feature is propagated (530) to the TMS (510) and to the ETMS (505). The administrator (500) creates rules (540) for the ETMS to allow the ETMS (505) to generate SPLs (545) for the TMS (510) for those features. The local manager (501) can also load digital cinema packages (DCPs) (550) into the TMS (510), the DCPs containing CPLs (clips) for playback. From these DCPs, the TMS (510) can provide the ETMS (505) information about what clips it has available (555). From this information, the ETMS (505) updates/creates SPLs (560) for the TMS (510). The local manager (501) can also add a show to the POS's schedule (570). The POS (515) then, in turn, sends an update request (575) regarding the schedule to the TMS (510). The TMS (510), in turn, updates the ETMS (505) with the POS's schedule (580), and the ETMS (505) can respond with an update to the TMS's schedule (585). The POS schedule is a list of show times that can be, for example, in the following format: date/time, movie name, auditorium number. The POS schedule is sent to the ETMS. ETMS knows how to map a movie name to a specific CPL (and, in turn, an SPL) and instructs the TMS to schedule the SPL for that time at the appropriate auditorium/screen.

The system can also be envisioned without a TMS (where the ETMS acts as the TMS for the theater). The system can also include SMSs controlled by the ETMS/TMS for screen management. The system can also work without a local manager, for example the features, show schedules, and DCPs can be automatically provided to the ETMS/TMS by a POS feed.

Hardware

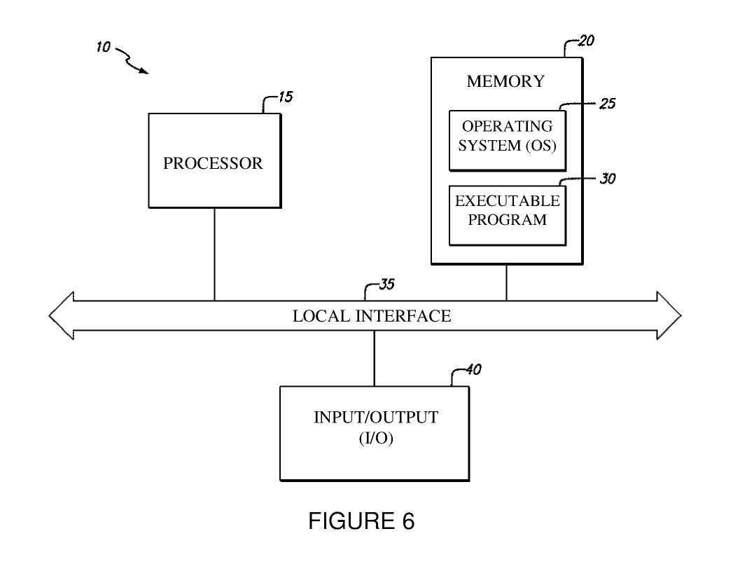

FIG. 6 is an exemplary embodiment of a target hardware (10) (e.g., a computer system) for implementing the embodiment of FIGS. 1 to 5. This target hardware comprises a processor (15), a memory bank (20), a local interface bus (35) and one or more Input/Output devices (40). The processor may execute one or more instructions related to the implementation of FIG. 1 to FIG. 5 and as provided by the Operating System (25) based on some executable program (30) stored in the memory (20). These instructions are carried to the processor (15) via the local interface (35) and as dictated by some data interface protocol specific to the local interface and the processor (15). It should be noted that the local interface (35) is a symbolic representation of several elements such as controllers, buffers (caches), drivers, repeaters and receivers that are generally directed at providing address, control, and/or data connections between multiple elements of a processor based system. In some embodiments the processor (15) may be fitted with some local memory (cache) where it can store some of the instructions to be performed for some added execution speed. Execution of the instructions by the processor may require usage of some input/output device (40), such as inputting data from a file stored on a hard disk, inputting commands from a keyboard, inputting data and/or commands from a touchscreen, outputting data to a display, or outputting data to a USB flash drive. In some embodiments, the operating system (25) facilitates these tasks by being the central element to gathering the various data and instructions required for the execution of the program and provide these to the microprocessor. In some embodiments the operating system may not exist, and all the tasks are under direct control of the processor (15), although the basic architecture of the target hardware device (10) will remain the same as depicted in FIG. 6. In some embodiments a plurality of processors may be used in a parallel configuration for added execution speed. In such a case, the executable program may be specifically tailored to a parallel execution. Also, in some embodiments the processor (15) may execute part of the implementation of FIGS. 1 to 5 and some other part may be implemented using dedicated hardware/firmware placed at an Input/Output location accessible by the target hardware (10) via local interface (35). The target hardware (10) may include a plurality of executable programs (30), wherein each may run independently or in combination with one another.

### Example System Features

In an embodiment of the system, the ETMS can notify the administrator and/or local manager if there are rules or clips that are missing for a complete CPL, if there are features not mapped to templates, or if there are mismatches between the rules and the data provided.

SPLs can include policy information for the features, such as specialized merchandise or promotional items tied to the feature.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A computer based system for managing one or more movie theaters, the system comprising:
an enterprise theater management system server, remote from the one or more movie theaters, configured to provide a show playlist to a movie theater of the one or more movie theaters based on a pre-defined ruleset.

2. The system of claim 1, further comprising:
a screen management system server associated with a screen at the movie theater, configured to play the show playlist on the screen.

3. The system of claim 2, further comprising:
a theater management system server associated with the movie theater, configured to provide the show playlist and a show schedule to the screen management system server.

4. The system of claim 2, wherein the enterprise theater management system server is configured to provide the theater management system server with a show schedule.

5. The system of claim 4, wherein the show schedule is based on information provided by a point of sale server.

6. The system of claim 1, further comprising:
a point of sale server associated with the movie theater, configured to provide feature information to the theater management system server;
wherein the theater management system server is further configured to provide the feature information to the enterprise theater management system server.

7. The system of claim 1, wherein the ruleset includes template rules and content rules.

8. The system of claim 1, wherein the ruleset propagates the fields of a template mapped to a feature film.

9. The system of claim 1, wherein the ruleset includes rules regarding one or more of location, time of day, date, feature rating, movie format, and feature content.

10. A computer based system for managing one or more movie theaters, the system comprising:
an enterprise theater management system server, remote from the one or more movie theaters, configured to provide a show playlist and show schedule to a movie theater of the one or more movie theaters based on a pre-defined ruleset.

11. The system of claim 10, further comprising:
a screen management system server associated with a screen at the movie theater, configured to play the show playlist on the screen based on the show schedule.

12. The system of claim 10, further comprising:
a point of sale server associated with the movie theater, configured to provide feature information to the enterprise theater management system server.

13. The system of claim 10, wherein the ruleset includes template rules and content rules.

14. The system of claim 10, wherein the ruleset propagates the fields of a template mapped to a feature film.

15. The system of claim 10, wherein the ruleset includes rules regarding one or more of location, time of day, date, feature rating, movie format, and feature content.
